(19) United States
(12) Patent Application Publication
(10) Pub. No.: US 2025/0307201 A1
(43) Pub. Date: Oct. 2, 2025

(54) Issuing of Chip-Configuration Requests to an On-Chip Configuration Control Bus

(71) Applicant: Graphcore Limited, Bristol (GB)

(72) Inventors: Graham Bernard CUNNINGHAM, Bristol (GB); Daniel John Pelham WILKINSON, Bristol (GB); Owain JONES, Bristol (GB)

(21) Appl. No.: 19/091,187

(22) Filed: Mar. 26, 2025

(30) Foreign Application Priority Data
Mar. 28, 2024 (GB) 2404448.9

(51) Int. Cl. G06F 15/173; G06F 13/42

(52) U.S. Cl. CPC G06F 15/17306; G06F 13/4282; G06F 2213/0024

(57) ABSTRACT

A plurality of chips each comprises a respective local chip-configuration control bus (Cbus). When a target chip ID of Cbus request obtained by a first chip matches a chip ID of the first chip, it supplies a target chip-configuration setting, specified by the Cbus request, via the local Cbus of the first chip, to the target chip-configuration register address within the local chip-configuration register address space of the first chip. But when the target chip ID matches a chip ID of a second chip, the first chip causes the Cbus request to be tunnelled over an inter-chip data interconnect to the second chip, where the second chip is configured to supply the tunnelled chip-configuration setting via the respective Cbus of the second chip to the target chip-configuration register address within the chip-configuration register address space of the second chip.

### CROSS-REFERENCE TO RELATED APPLICATIONS

The present application claims priority to United Kingdom Patent Application No. GB2404448.9, filed Mar. 28, 2024, the disclosure of which is hereby incorporated herein by reference in its entirety.

### TECHNICAL FIELD

The present disclosure relates to a mechanism for issuing chip-configuration requests over a chip-configuration control bus onboard a chip, in order to configure low-level chip-configuration registers of the chip which are addressable via the chip-configuration control bus.

### BACKGROUND

It is known to network together multiple chips to form a wider computer system. For example, a processor on one chip may be supported by one or more external memory controller chips connected to the processor chip via an inter-chip interconnect (e.g. comprising one or more Ethernet links from the processor chip to each memory controller chip). The processor may be an accelerator processor which is allocated work (processing tasks) by a host. As another example multiple such processor chips may be networked together such that the processing performed by each the processor on each chip contributes to a wider, common application designated by the host. In at least one such system, multiple accelerator processors and multiple memory controllers are networked together, such that each processor can communicate with memory or another of the processors via the memory controllers, and the network as a whole can perform work allocated by the host. The chips may for example be located on the same board, or on different boards within the same server unit, or a combination. The accelerator processors may for example be of a design by the applicant known as an IPU (Intelligence Processing unit), optimized for machine learning applications.

Each chip in the network will need to be configured. For example, one or more pins of the chip may have a pseudo-statically programmable function and the configuration may comprise setting whether each of one or more such pins is configured as an input pin or an output pin. Another example would be programming a chip ID into a dedicated chip ID register of the chip, which may for example determine the chip's position in a topology of the network. Another example of chip configuration is to configure a source of global timing information for the chip. Other examples include configuring a block of logic on the chip, and event reporting and handling.

The configuration of a given chip is set by settings programmed pseudo-statically into chip-configuration registers on the chip. I.e. the values of the configuration settings are programmed once prior to beginning a data processing job to be performed by the chip (e.g. a job to be performed in software run on the chip), and then the configuration settings remain static throughout the job). Each chip comprises a local on-chip control bus for distributing configuration settings to the control registers of the chip. A bus is required because the control registers are distributed at different physical locations around the chip, because they are arranged to configure low-level configurations of hardware features of the chip and hence typically need to be located close to the hardware that they are configuring. For example a register that configures whether a pin is an input pin or an output pin will need to be located physically close to the pin.

To enable configuration or reconfiguration of a chip in a network, each chip is provided with an interface to the host, such as a PCI interface connecting to the host via a PCI bus. The host issues chip-configuration requests to a given chip via the PCI bus, which are then supplied to the local control bus by the host interface logic on board that chip. Chip configuration requests may also be issued by microcontrollers. For example, the chips of the network may initially be configured by their microcontrollers, and then the host may issue an initial batch of work to be performed by the network. After the initial batch of work, the host (rather than the microcontrollers) may then reconfigure the network and then issue a new batch or work.

### SUMMARY

An issue with existing arrangements is that each chip is provided with its own interface to the host to enable the host to configure (or reconfigure) each chip. However this takes up a lot of physical space due to the physical connectors. E.g. if the host uses a PCI bus then each chip needs its own PCI connector on the board on which it is implemented. It is recognized herein that it would be desirable to provide a mechanism for delivering with control bus requests from a host to all chips in a network without requiring every chip to have its own direct interface to the host.

According to one aspect disclosed herein, there is provided computer system comprising: a plurality of chips, an inter-chip data interconnect, and a host. Each of the plurality of chips comprises a respective local chip-configuration control bus arranged to communicate chip configuration settings to chip-configuration registers of the chip and thereby configure the chip, each chip-configuration register having an address within a local chip-configuration register address space of the respective chip. The inter-chip data interconnect is arranged to communicate application data content between different ones of the chips. A first of the plurality of chips is connected to the host via a host interconnect other than the inter-chip data interconnect, but a second of the plurality of chips is not connected to the host other than via the first chip and the inter-chip data interconnect. The first chip is arranged so as: a) based on information from the host received via the host interconnect, to obtain chip-configuration requests each comprising a target chip ID specifying a target chip from among the plurality of chips, a target chip-configuration register address specifying a target chip-configuration register on the target chip, and a target chip-configuration setting. The first chip is further configured so as b) when the target chip ID matches a chip ID of the first chip, to supply the target chip-configuration setting via the local chip-configuration control bus of the first chip to the target chip-configuration register address within the local chip-configuration register address space of the first chip. The first chip is further configured so as c) when the target chip ID matches a chip ID of the second chip, to cause the chip-configuration request to be tunnelled over the inter-chip data interconnect to the second chip, where the second chip is configured to supply the tunnelled chip-configuration setting via the respective chip-configuration control bus of the second chip to the target chip-configuration register address within the chip-configuration register address space of the second chip.

The disclosed mechanism thus takes a control request that was formulated by the host for a local control bus and wraps it up in the protocol of the inter-chip data link so as to tunnel a control bus request over the inter-chip data link. Control bus packets can be either be targeted at the local chip or a remote chip. Control bus packets to a remote chip travel within a chip as control bus packets and when travelling between chips they are tunnelled over inter-chip links (e.g. Ethernet links). In embodiments this is done by placing the entire control bus packet contents within an Ethernet frame.

### BRIEF DESCRIPTION OF THE DRAWINGS

To assist understanding of embodiments of the present disclosure and to show how such embodiments may be put into effect, reference is made, by way of example only, to the accompanying drawings in which:

FIG. 1 is a schematic illustration of a chip comprising a chip-configuration control bus,

FIG. 2 is a schematic block diagram of a computer system comprising multiple chips in accordance with one example embodiment disclosed herein,

FIG. 3 is a schematic block diagram of a multi-tile processor chip in accordance with examples embodiments disclosed herein,

FIG. 4 is a schematic block diagram of a memory module in accordance with embodiments disclosed herein,

FIG. 5 is a schematic block diagram of a memory controller chip in accordance with embodiments disclosed herein, and

FIG. 6 illustrates a method of routing chip-configuration requests between chips in accordance with embodiments disclosed herein.

### DETAILED DESCRIPTION OF EMBODIMENTS

The following describes a system in which a host can write to the configuration space associated with multiple chips by issuing requests through a single unified address space, such as a single PCIe BAR. A control bus (Cbus) initiator determines a chip ID, which identifies the chip that is being targeted by the request. If the chip ID matches the chip ID of the chip on which the request is received, then a local Cbus request that targets a register on that chip is initiated via the chip's Cbus. On the other hand if the chip ID does not match the chip ID for the chip, then a Cbus request carrying the chip ID value as additional metadata and targeting an inter-chip link (e.g. IPU link) is made. This request with the metadata is tunnelled via the inter-chip link to another chip, where either a local Cbus request is made (if the chip ID matches for that chip) or a Cbus request targeting another link to a further chip (if the chip ID does not match for that chip) is made

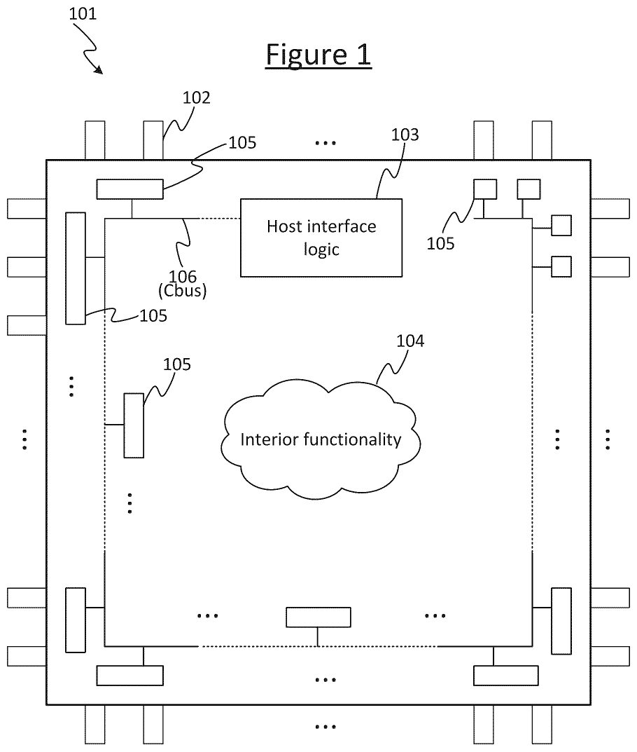

FIG. 1 shows a chip 101 comprising a plurality of pins 102, host interface logic 103, interior functionality 104, a plurality of chip-configuration control registers 105 and a chip-configuration control bus 106. A chip in this context refers to an integrated circuit (IC) die. Different chips could be packaged in different IC packages, or in the same IC package, or a combination of some in the same package and some in different packages. The interior functionality 104 represents whatever primary functionality the chip 101 was designed for, e.g. a processor for executing code, or a memory controller for interfacing to an external memory such as a DRAM.

The chip-configuration control bus 106 may be referred to herein as the “Cbus” for short, though this is not intended to limit to any specific bus protocol or design. It connects the host interface logic 103 to each of the chip-configuration registers 105, which may be distributed at different physical points around the chip. E.g. if a chip-configuration register 105 configures the function of a given pin or group of pins then it may be located physically close to the pin (i.e. the location of the register 105 in the silicon layout will be close to the location of the pin in the corresponding IC package when the chip is [packaged in the IS package). The chip-configuration registers configure low-level aspects of the chip, including hardware features. For instance some of the chip-configuration registers may be pin-configuration registers, each of which configures a hardware function of one or more associate pins of the IC package in which the chip is packaged. E.g. some pins may be configurable as to whether they are input pins or output pins, and a configuration register associated with each such pin may set whether it is an input pin or an output pin.

As another example, a chip 101 may comprise one or more hardware modules (blocks of hardware logic) that can be individually enabled and disabled, or otherwise configured. For since, such a module may comprise a certain type of interface that may be used on some instances of the chip and not others. For example different instances of a chip may be manufactured as identical but be given have different roles within the network such that some of them will use the module in question and some will not. In this case, in order to save power, the module in question may be disabled on those instances of the chip that do not use it. This may be done via one of the chip-configuration registers 105.

As another example of chip configuration, the chip 101 may comprise a register into which its chip ID is programmed. For example the chip ID may determine or reflect a position of the chip 101 in a topology of a network of chips (e.g. on a board or within a server unit), and may be used for routing messages between chips in the network. The chip ID register may be one of the chip-configuration registers 105

As a further example, chip configuration registers 105 may enable an external entity such as a host to drive a value onto a pin, or to read a value from a pin. And/or configuration registers 105 may also allow for the injection of other debug state into the interior of the chip 101, or the reading out of other debug state from the interior of the chip. Driving a value onto a pin or reading a value from a pin relates to the state of external pins, whereas injecting state relates to internal logic state.

Another example of chip configuration is to configure (e.g. set or enable/disable) a source of global timing information for the chip. For instance this may comprise enable or disabling a master on-chip clock, resetting the master clock, setting a frequency of the mater clock, or sending periodic updates to keep all the local clocks within the system synchronised to the master clock (e.g. for a multi-chip system where all the clocks need to be aligned).

Yet another example of chip configuration is event reporting and handling. Configuring event reporting or handling comprises configuring error handler or debugging circuitry which automatically raises exceptions (error signals or the like, to indicate anomalous or exceptional conditions) or outputs debugging state. E.g. such exceptions may arise from attempting to access a configuration register which doesn't exist, or may report link failures, memory or logic failures, or processor exceptions.

The Cbus 106 enables particular values of the settings represented by the control registers 105 to be programmed into those registers. Each chip-configuration register 105 has an associated address within a chip-configuration address space of the chip 101. E.g. the chip-configuration address space may comprise a range of 512 kbytes. Each Cbus request issued onto the Cbus 106 comprises a target setting and a target address (i.e. destination address) within the local address space of the chip 101, and based on this the Cbus 106 will deliver the target setting to the configuration register 105 with the target address in order to program that register with that setting.

The host interface 103 enables a host to access the Cbus 106 in order to issue Cbus requests and thereby set the values in the chip-configuration registers. In embodiments the host interface may be a PCI interface, connecting to the host via a PCI bus. The PCI interface be PCIe or PCI-X interface, for example.

In some cases the Cbus may also be accessible by an on-chip or off-chip microcontroller or CPU other than the host. For example the chip 101 may be initially configured upon boot by a microcontroller, but after boot the host may reconfigure the chip 101 between workloads.

In accordance with the present disclosure, there is provided a network of chips 101 in which in some (but not all) the host interface logic 103 is not present, or is disabled, or at least is simply not connected to a host. However each chip 101 still comprises a local Cbus 106 and its own set of chip configuration registers 105 which still need configuring. To enable such a scenario, the presently disclosed system and method employ tunnelling of the low-level Cbus requests over an inter-chip data link (e.g. an ethernet link) that was designed for the transfer of higher-level application data content.

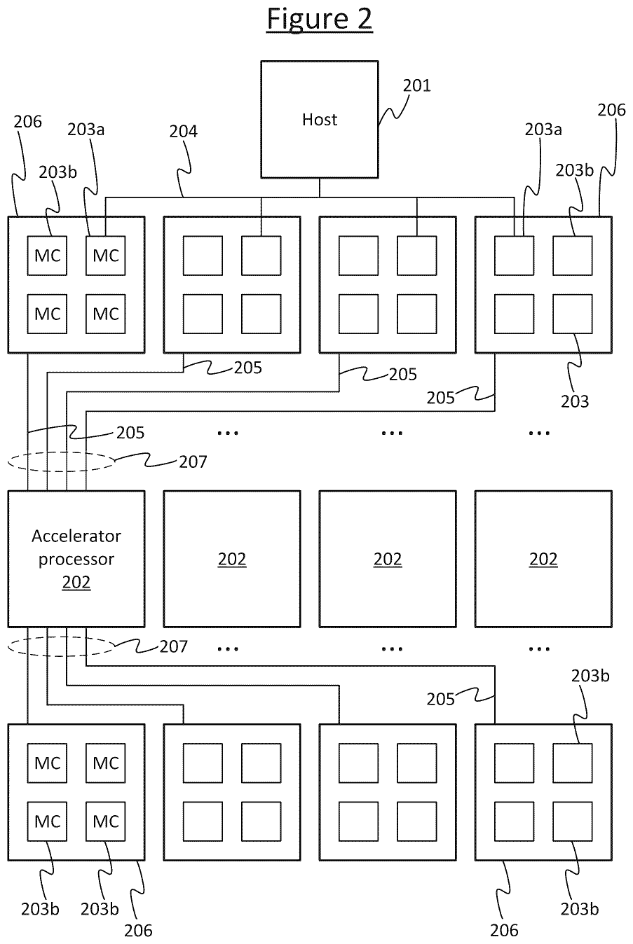

FIG. 2 shows an example computer system in accordance with embodiments of the present disclosure. The system comprises a host 201, and a network of chips 202, 203. The host 201 is a subsystem comprising at least one host processor. E.g. the chips may include one or more memory controller chips 202, and/or one or more processor chips 203 such as accelerator processors.

The chips 202, 203 could be chips (dies) in different IC packages or different chips within the same IC package, or a combination of some in the same package as one another and some in different packages. The packages could be mounted on the same board as one another or different boards with the same unit, e.g. same rack-mounted server unit, or different units in the same rack.

The host 201 could comprise a single host CPU or a plurality of host CPUs. The host 201 may comprise just the host CPU(s), or the host CPU(s) plus additional components such as host memory. The host may for example be mounted on the same board as the network of chips 202, 203; or on a different board housed in the same unit, or a different unit in the same rack or data centre.

Whatever form it takes, the host 201 has at least two roles: configuring the chips 202, 203; and allocating work (i.e. processing jobs) to be performed by the network of chips 202, 203. To these ends the host 201 is connected to the network via a host interconnect 204. For example the host interface may take the form of a PCI bus. Note that “PCI” as referred to herein covers any standard in the PCI family, e.g. any of the original PCI standards PCI 1.0 to 3.0, or an extension or subsequent generation such as PCIe or PCI-X. More generally an “interconnect” as referred to herein can refer to any one or more buses, or set of individual links or any other means of connecting between different components.

Each of the chips 202, 203 has a respective Cbus 106 and its own respective set of chip-configuration registers 105 as shown of the chip 101 of FIG. 1, except that some of the chips 202, 203b either do not have the host interface logic 103 or have the host interface logic 103 disabled or at least disconnected. A first one or more of the chips 203a have an operational (e.g. enabled) instance of the host interface logic 103 (e.g. PCI interface logic) that is connected to the host 201 via the host interconnect (e.g. PCI bus) 204. On the other hand, a second one or more of the chips 202 do not connect directly to the host interconnect 204 (e.g. because they have no host interface logic 103, or their host interface logic is disabled or disconnected). This may be advantageous for example because there is not enough physical space to include a physical connector to the host for every individual one of the chips 202, 203; e.g. if they are mounted on the same board or within the same server unit or other such module, then there may not be enough space on the board or within the module to provide a separate physical connector (e.g. PCI connector) to the host interface (e.g. PCI bus) 204 for each individual one of the chips 202, 203 in the network. Hence in embodiments an individual respective physical connector for connecting to the host 201 is not included for each second chip 202. Other alternative or additional motivations could include saving silicon area by not including am instance of the host interface logic 103 on every chip 202, 203; or saving power by not enabling the host interface logic 103 on every chip 202, 203.

Each of the one or second chips 202 is connected to at least one of the one or more first chips 203a an inter-chip data interconnect 207. For example, in embodiments the inter-chip data interconnect may comprise an individual chip-to-chip link (e.g. Ethernet link) 205 or bundle of links from each second chip 202 to one of the first chips 203a. In other words the inter-chip interconnect 207 may comprises a set of individual links 205 comprising at least one link between each of a plurality of pairs of chips 202, 203 (i.e. with no common bus or central hub or routing entity). Alternatively however it is not excluded that the inter-chip interconnect 207 may take the form of a central bus or another form of network of links that involves routing. Again, the term “interconnect” per se as used herein can refer to any means of connecting between components.

Whatever form it takes, the inter-chip interconnect 207 is primarily designed or intended for transferring application data between the chips 202, 203 (e.g. data software produced by or destined for software run on one of the chips), and is used for that purpose. For instance if the application is machine learning, the data communicated between chips 202, 203 could comprise training data, neural network weights, and or results of predictions made by the machine learning model run on the system. However, as an additional function in accordance with the present disclosure, one or more links 205 of the inter-chip data interconnect 207 are also used to tunnel Cbus requests from a first chip 203a to a second chip 202.

The host 201 issues a request onto the host interconnect 204, which causes the host interface logic 103 on at least one of the first chips 203a to form a Cbus request based on the request from the host. For example, the host 201 issues a native interconnect request (e.g. a PCIe read) onto the host interconnect 204 (e.g. PCIe), targeted at the CBus region of the relevant BAR. The receiving device converts this into a Cbus request, wherein the Chip ID and Cbus address information in the Cbus request is formed by decoding the PCIe address field. A look-up table is used to determine the Cbus target ID on the current chip to send the tunnelled request to (and thus the chip-chip link to use), based on the Chip ID in the packet.

Each Cbus request may take the form of a receptive Cbus packet (formulated according to a packet protocol of the Cbus 106). In the case that the network comprises multiple first chips 203a (i.e. multiple chips are connected to the host), then depending on implementation, the message from the host 201 may be routed to a specified one or more of the first chips 203a for processing, or may be sent to each connected first chip 203a. In embodiments there will be only one first chip 203a to which the host sends a request, since in preferred implementations all requests are expected to complete or to signal an error and the network is lossless, so re-transmissions are not required, and the chips 202, 203 are connected in a topology such that all downstream chips 202, 203b can be reached via a single entry point (the first chip 203a). As such it may not be required to send two copies of the same request via two different routes. However it is not excluded that the host 201 could send a request to more than one first chip. In that case the message could be processed in parallel by all the receiving first chips 203a, or alternatively each could determine whether the message is directed to that chip and select whether or not to process it accordingly. For example, the chips 202, 203 may be arranged in a topology whereby each of multiple first chips 203a serves its own, exclusive subtree, and the host 201 can send a duplicate of the same message content to each. Alternatively if the topology is such that it may result in any chip or chips 202, 203 receiving the same request via two or more different routes, then that/those chips may be configured with logic to identify duplicates of a request it has already seen (though as noted, such an implementation may be deemed unnecessary, e.g. in a lossless environment).

By whatever means delivered to one of the first chips 203a, the Cbus request comprises a target chip-configuration register address and a target setting. The target chip-configuration register address specifies an address of at least one of the chip-configuration registers 105 within the address space of a given chip 202, 203. The target setting specifies a value to be programmed into that register. In accordance with the present disclosure, the Cbus request also comprises a target chip ID specifying which chip 202, 203 is the target chip, i.e. which is the target configuration setting destined for.

A first one or more of the chips 203a can receive Cbus requests directly from the host 201 via the host interconnect 204 and the host interface logic (e.g. PCI interface) 103 on the respective first chip 203a. The Cbus requests may be received via a same path of the host interconnect 204 that is also used to allocate work, or via a separate path (e.g. the host interconnect 204 comprising a separate bus for data and configuration).

On any given one of the first chips 203a that receives the Cbus request from the host 201, the host interface logic 103 on the respective first chip 203a inspects the target chip ID and based thereon determines whether the Cbus request is destined for that first chip 203a itself. If so, the host interface logic 103 on the first chip 203a routes the request over the local Cbus 106 on the first chip 203a to the specified target address within the address space of the local Cbus 106 of the first chip 203a (i.e. to the chip-configuration register 105 having that address within the local address space of the Cbus 106 on the respective first chip 203a).

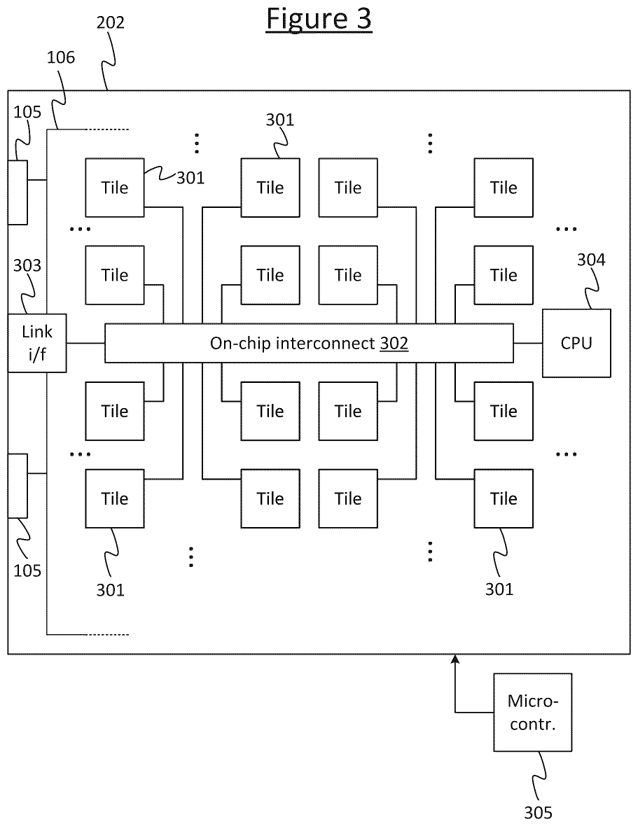

On the other hand, if the host interface logic 103 on the receiving first chip 203a determines based on the target chip ID that the Cbus request is destined for another chip 202, 203b, then it routes the Cbus request onward, through inter-chip link interface logic 503a on the first chip 203a (e.g. see also FIGS. 5&6), and over at least one link 205 of the inter-chip interconnect 207, to at least one of the one or more second chips 202 to which the first chip 203a is connected via the inter-chip interconnect 207. The second chip 202 is one of the chips that does not have a physical connector to the host 201 and/or does not have its own host interface logic 103, or at least does not have its 103 host interface logic enabled. It does however comprise inter-chip link interface logic 303 (shown in the example of FIG. 3, to be discussed in more detail shortly). Each second chip 202 is connected to at least one respective first chip 203a via at least one link 205 of the inter-chip interconnect 207, and the link interface logic on the first chip 203a. Conventionally this interconnect 107 is only used to communicate application-level data (e.g. data to be processed, or instructions for work allocation from the host 201), but according to the present disclosure the inter-chip link logic and one or more links 205 of the inter-chip interconnect 207 can also be used for tunnelling Cbus requests for low-level chip configuration between chips.

The Cbus request in itself is formulated in the protocol of the Cbus 106, designed only for local (on-chip) communication of chip-configuration settings over the Cbus (control bus 105). However the inter-chip interconnect 207 will use a different protocol, referred to herein as the link protocol, e.g. ethernet. In order to forward the Cbus request to a second chip 202 over a link 205 of the inter-chip interconnect 207, the host interface logic 103 on the forwarding first chip 203a wraps the Cbus request in the link protocol of the inter-chip interconnect 207, e.g. in an ethernet frame. Such a technique is known as tunnelling. Wrapping one protocol in another may comprise, for example, taking the Cbus request formulated in the Cbus protocol and adding a header of the inter-chip link protocol (thus the request in the Cbus protocol becomes the payload of the link protocol).

This link interface logic 303 on the (or each) second chip 202 in receipt of a forwarded Cbus request inspects the chip ID specified in the request, and based thereon determines whether the request is determined for that respective receiving second chip 202. If so the link interface logic 303 on the receiving second chip 202 routes the request over the local Cbus 106 on the respective second chip 202 to the specified target address within the address space of the local Cbus 106 of that second chip 202 (i.e. to the chip-configuration register 105 having that address within the local address space on the respective second chip 202).

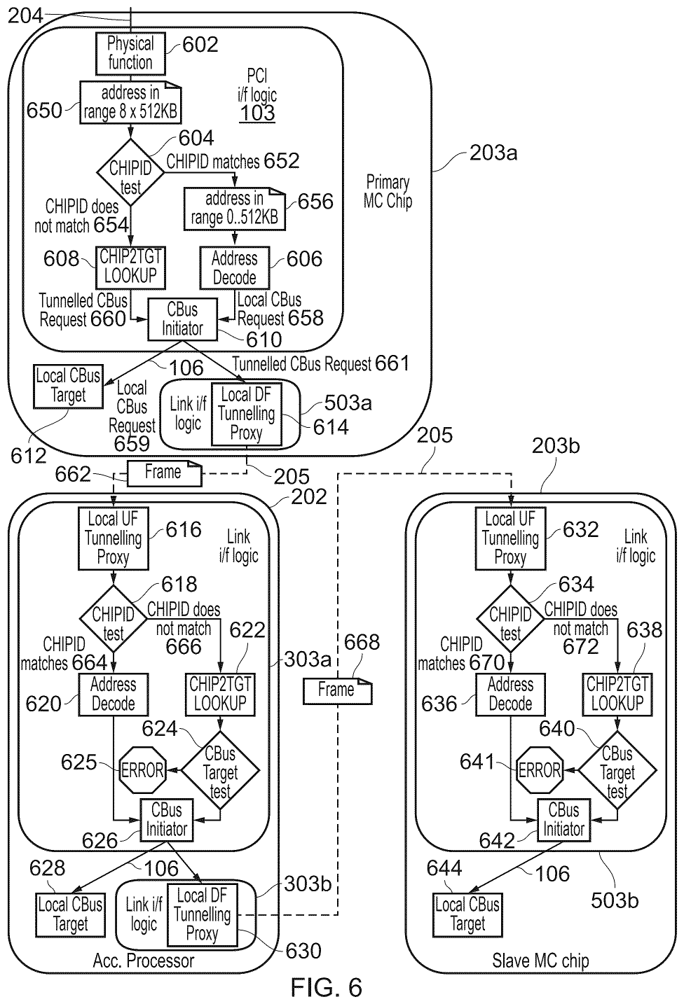

In embodiments, the network further comprises one or more third chips 203b. Each of these is a chip that that does not have a physical connector to the host 201 and/or does not have its own host interface logic 103, or at least does not have its host interface logic 103 enabled. It does however comprise inter-chip link interface logic 503b (e.g. as shown in the examples of FIGS. 5 and 6, to be discussed in more detail shortly). Further, unlike the second chips 202, the third chips 203b are not connected directly to any of the one or more first chips 203a. However each third chip 203b is connected via the inter-chip interconnect 207 to at least a respective one of the one or more second chips 202.

If a second chip 202, in receipt of a forwarded Cbus request, determines based on the chip ID specified in the forwarded Cbus request that the request is not destined for that second chip 202, then it forwards the Cbus request onwards over the inter-chip interconnect 207 to at least one of the one or more third chips 203b. Again the Cbus request is tunnelled over the-chip interconnect 207 by being wrapped in the protocol of the inter-chip interconnect.

The link interface logic 503 on the (or each) third chip 203b in receipt of a forwarded Cbus request inspects the chip ID specified in the request, and based thereon determines whether the request is determined for that respective receiving third chip 203b. If so the link interface logic 303 on the receiving second chip 202 routes the request over the local Cbus 106 on the respective second chip 202 to the specified target address within the address space of the local Cbus 106 of that second chip 202 (i.e. to the chip-configuration register 105 having that address within the local address space on the respective second chip 202). If not however, in some embodiments the third chip 203b may raise an error signal.

In general, depending on implementation, there could be any number of tunnelled hops of the Cbus request before it finds its destination. The host interface logic 103 or link interface logic 303, 503 on each chip 202, 203 that receives a Cbus request examines the target chip ID specified in the request, and if it matches the chip ID of the receiving chip, routes it over that chip's own local Cbus 106 to the target address specified in the request; but if the chip ID does not match, the logic forwards the Cbus request onwards to one or more other chips 202, 203b via one or more links 205 of the inter-chip the interconnect 207 (or if there are not further potential hops available, in embodiments raises an error signal). Cbus packets can be either be targeted at the local chip or a remote chip. Cbus packets to a remote chip travel within a chip as Cbus packets and when travelling between chips they are tunnelled over inter chip (e.g. Ethernet) links 205, by wrapping the Cbus request packet in the protocol of the inert-chip interconnect 207 (e.g. placing the entire Cbus packet contents within an Ethernet frame).

In embodiments the chips 202, 203 in the network comprise one or more memory controllers 203 and one or more accelerator processors 202. The memory controllers 203 process accesses to memory on behalf of the host 201 and/or accelerator processors 202. The accelerator processors 202 run software to process tasks allocated to them by the host 201. The processing of the tasks by the accelerator processors 202 may involve processing data retrieved by the memory controllers 203. The memory controllers allow multiple accelerator chips to share access to the same memory devices, potentially providing each accelerator with more memory capacity and bandwidth than is possible if the memory were directly connected to the accelerator. Also, among other things this makes the system more modular, moves temperature sensitive memories away from the accelerator which is liable to be hot, allows more space for power supplies to be placed very close to the accelerator where they will be more efficient.

FIG. 3 shows an example of an accelerator processor 202 in accordance with one implementation. One, some or all of the accelerator processors 202 in the network of FIG. 2 may each be an instance of the processor shown in FIG. 3. As well as the components described in relation to FIG. 1, the accelerator processor 202 may comprise a CPU 304, and/or a plurality of tiles 301. In the case of multiple tiles 301, the tiles are connected together via an inter-tile interconnect 302. Each tile 301 comprises its own respective execution unit and memory such that each tile can run respective code in parallel with the other tiles. In the case of multiple tiles 301 and a CPU 304, the CPU 304 may also be connected to the tiles 201 via the on-chip interconnect 302. The accelerator processor 202 may for example be an AI accelerator processor designed for AI applications such as machine learning (e.g. training neural networks). Other example types of accelerator processor include e.g. GPUs (graphics processing units), crypto-processors, and digital signal processors.

The accelerator processor (or more generally second chip) 202 also comprises an inter-chip link interface logic 303 for connecting to at least one first chip 203a via at least one link 205 of the inter-chip interconnect 207. This may be used both for conventional transfer of application content, and for the tunnelling of Cbus requests in accordance with the techniques disclosed herein. The link logic 303 is also operatively coupled to the local Cbus 106 on the respective chip so as to be able to route received Cbus requests addressed to the local chip ID to the local chip-configuration registers 105.

The host-interface logic 103 may not be present on the accelerator processor (or more generally second chip 202, or may be present but deactivated.

In embodiments, the chip-configuration registers 105 of the accelerator processor (or more generally second chip) 202 may be initially configured by the host 201 using the tunnelling described herein, or by another entity such as the CPU 304 or one or more microcontrollers 303 connected to the accelerator processor/second chip 202. Once the initial configuration is set, then the host 201 may allocate a first batch of work to be performed by software run on the accelerator processor 202. After the first batch of work has been processed, the host 201 may then reconfigure the settings in the chip-configuration registers 105 of the accelerator 202 using the tunnelling mechanism described herein, and then reallocate a second batch of work to be processed by software on the accelerator processor 202, which is now operating under the reconfigures settings rather than the initial settings. Work may be allocated via same path of the host interconnect 204 as Cbus requests, or separate path (e.g. separate bus for work and configuration). In embodiment the chip-configuration registers 105 of the accelerator processor 202 are initially configured by the CPU 304 or microcontroller 303, e.g. upon boot, and then later reconfigured by the host 201 using the tunnelling mechanism disclosed herein.

FIG. 5 shows an example of a memory controller 203. In embodiments, one, some or all of the memory controllers 203 in the network of FIG. 2 may each be as shown in FIG. 5. As well as the components described in relation to FIG. 1, the memory controller 203 comprises a memory interface 501 such as a DDR interface for interfacing to a memory such as a DRAM.

The memory controller (or more generally first or third chip) 203 also comprises an inter-chip link interface logic 503 for connecting to at least one second chip 202 via at least one link 205 of the inter-chip interconnect 207. This may be used both for conventional transfer of application content, and for the tunnelling of Cbus requests in accordance with the techniques disclosed herein. The link logic 503 is also operatively coupled to the local Cbus 106 on the respective chip so as to be able to route received Cbus requests addressed to the local chip ID to the local chip-configuration registers 105.

The host-interface logic 103 may not be present on the memory controller (or more generally third chip) 203b if it does not connect to the host 201, or may be present but deactivated. In the case of being a first chip 203a the host-interface logic 103 is present and activated, and connected to the host interface 204.

As shown in FIG. 2, in embodiments a plurality of memory controllers 203 may be grouped together into a memory module 206. In some cases there may be multiple memory modules 206, with each comprising a different respective subset or the memory controllers 203 in the network. E.g. each module 206 may be implemented on its own respective board or card, or in a respective IC package if multiple dies are packaged in the same package. In the case of multiple memory modules 206, the different memory modules may be implemented on/in different respective boards, cards or IC packages.

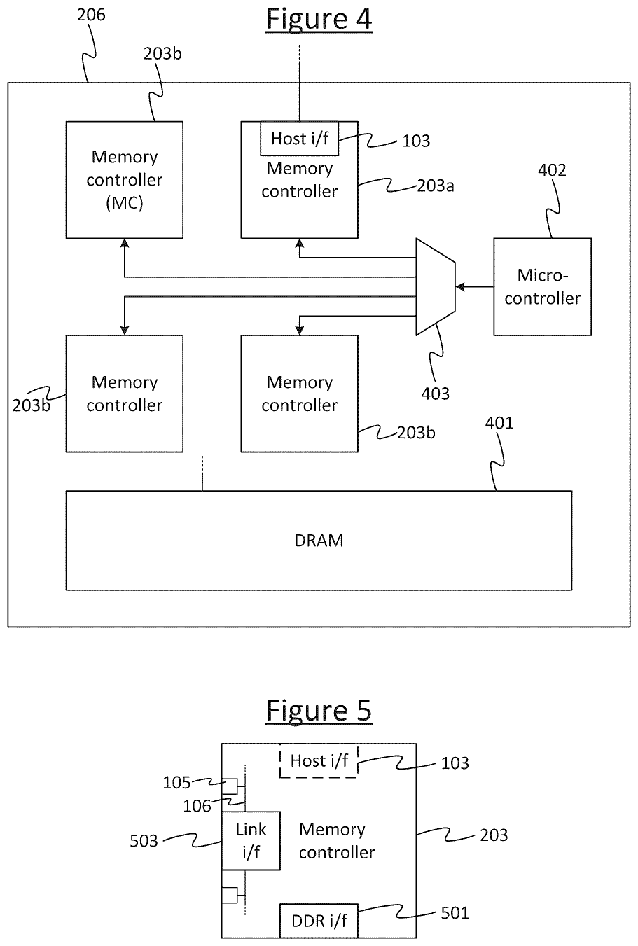

FIG. 4 shows an example of a memory module 206 comprising a respective plurality of the memory controllers 203. The memory module 206 provides access to a respective data memory 401, e.g. DRAM or SRAM, which may be incorporated as part of the module or may be external. Each memory controller 203 on a given memory module 206 is connected to the respective memory 401 of that module 206 via the memory interface 501 of the memory controller 203.

Each memory module 206 may comprise at least one memory controller 203 configured as one of the first chips 203a (having an active host interface logic 103 connected to the host 201 via the host bus 204), and at least one memory controller 203 configured as one of the third chips 203b (either not having its own host interface logic 103 or not having it activated). In embodiments only one of the memory controllers 203 per memory module 206 is configured as a first chip 203a, and the rest are third chips 203b. The first chips 203a may be referred to herein as master memory controllers and the third chips 203b may be referred to herein as slave memory controllers.

The memory module 206 may also comprise a microcontroller 402 shared between the memory controllers 203 in the same module 206 as one another. In this case the memory module 206 comprises switching circuitry 403 arranged to selectively connect the microcontroller 402 to any selected one of the memory controllers 203 on board the respective memory module 206, enabling the microcontroller 402 to set the settings in the configuration registers 105 of the selected memory controller 203. Alternatively it is not excluded that an individual microcontroller 402 may be provided for each memory controller 203, or that there may be only memory controller 203 per memory module 206.

Each first chip 203a and third chip 203n on each memory module 206 also comprises respective inter-chip link interface logic 503 connected to at least one of the accelerator processors 202 via at least one link 205 of the inter-chip interconnect 207.

In embodiments, the chip-configuration registers 105 of the memory controllers (or more generally first and/or third chips) 203 may be initially configured by the host 201 using the tunnelling described herein, or by another entity such as the respective microcontroller 402. Once the initial configuration is set, then the host 201 allocates a first batch of work to be performed by software run on one or more of the accelerator processors 202, which may involve one or more accelerator processors being supplied with application data content from memory 401 via one or more of the memory controllers 203, and/or application data content output by one or more accelerator processors 202 being stored in memory 401 via one or more of the memory controllers 203. After the first batch of work has been processed, the host 201 may then configure the settings in the chip-configuration registers 105 of one or more memory controllers 203 and/or accelerator processors 202 using the tunnelling mechanism described herein, and then reallocate a second batch of work to be processed by software on the accelerator processors 202 (which again may involve one or more accelerator processors being supplied with application data content from memory 401 via one or more of the memory controllers 203, and/or application data content output by one or more accelerator processors 202 being stored in memory 401 via one or more of the memory controllers 203). In embodiments the chip-configuration registers 105 of the memory controllers 203 are initially configured by the respective microcontroller(s) 403, e.g. upon boot, and then later reconfigured by the host 201 using the tunnelling mechanism disclosed herein.

In embodiments there are multiple accelerator processors 202 and multiple memory modules 206. The memory controllers 203 may be physically identical to one another, so each has the same host interface logic 103 (e.g. PCI logic) and pins, but the host interface logic 103 is disabled on some of the memory controller chips 203 on each module 206—so not saving space on the memory module 206 itself, but deactivating some of the interfaces does save power consumption. Also even if every memory controller 203 has a host interface (e.g. PCIe interface) 103, it may be that not all of them can realistically be connected to the host 201 since the memory module 206 may be limited in the number of connector pins it has to the baseboard, or the amount of space available for the physical routing of wiring on the board. Using the inter-chip tunnelling mechanism for the tunnelling of control-bus (Cbus) requests as disclosed herein, this advantageously enables the host 201 to be able to configure the configuration registers 105 of chips such as memory controllers 203b without necessarily having to be directly connected to all of them.

With regard to the accelerator processors 202, in embodiments none of these may have a suitable interface (e.g. PCIe interface) 103 for connecting to the host 201, but it is still desirable to access its chip-configuration registers 105 from the host 201. Using the inter-chip tunnelling of Cbus requests as disclosed herein, this advantageously enables the host 201 to be able to configure the configuration registers 105 of chips such as accelerator processors 202 that do not have their own direct interface 103.

In some embodiments, each memory controller 203 may also have its own respective on-chip microcontroller (not shown), and it may be desired that this also has access to configuration registers 105 on an accelerator processor 202 and/or other memory controllers 203. This may be also achieved using the inter-chip tunnelling mechanism disclosed herein.

FIG. 6 shows an example method in accordance with embodiments of the techniques disclosed herein. Any of the functions discussed below may be implemented in dedicated hardware circuitry, configurable or reconfigurable circuitry (such as a PGA or FPGA), or in software, or any combination of circuitry and software.

The host interface logic 103 of the first chip 203a (e.g. a master memory controller) comprises a physical interface function 602, a chip ID test function 604, a chip-to-target (CHIP2TGT) look-up table function 608, an address decoder function 606, and a Cbus initiator function 610. In operation the physical interface function 602 receives a information from the host 201 via the host interface 204. This function 602 extracts an address 650 from the received information, the extracted address comprising i) the target chip ID identifying the target chip from among the multiple chips 202, 203; and ii) the target address within the address space of the Cbus on a given chip. Based on this the physical function 602 forms a Cbus request packet. The test function 604 then tests whether the extracted target ID of the Cbus request matches the chip ID of the current chip (i.e. here the first chip) 203a. If so it takes the local target address 656 (the address within the local address space) from the wider target address 650, and supplies it to the address decoder 606 to decode the local target address. Based on this the address decoder 606 a local Cbus request 658 to the Cbus initiator 105, which issues a corresponding local Cbus request 659 to the local Cbus target 612 (one or the local chip-configuration registers 105) via the Cbus 106. The local Cbus request 659 comprises the setting from the Cbus request to set into the target register 105/612.

On the other hand, if the test function 604 determines that the target chip ID does not match the local chip ID, then it outputs an indication 654 of the non-matching target chip ID to the chip-to-target look-up table function 608, which looks up the target in a chip-to-target look-up table (e.g. which may be programmed into registers of the local chip). Based on this the look-up function 608 determines which other chip the Cbus request is addressed to, and sends a tunnelled Cbus request 661 to a local downstream-facing (downlink-facing) (DF) tunnelling proxy 615 of the inter-chip interface logic 503a of the first chip 203a. This then sends a tunnelled Cbus request 662 to the inter-chip interface logic 303a in the second chip 202 (e.g. accelerator processor). The request may be forwarded to the second chip 202 either because the look-up function determined that the second chip 202 was the target chip, or because it determined that the target chip is another chip (e.g. a third chip 203b such as another memory controller) to which the first chip 203a is not directly connected via its own inter-chip link interface logic 503a.

The inter-chip interface logic 303 of the second chip comprises upstream-facing (uplink-facing) logic 303a and downstream-facing (downlink-facing) logic 303b. The upstream-facing logic 303a comprises an upstream-facing (UF) tunnelling proxy function 616, a chip ID test function 618, an address decoder 620, a chip-to-target look-up table function 622, a Cbus target test function 624, and a Cbus initiator function 626. The upstream-facing tunnelling proxy function 616 receives the tunnelled Cbus request 662 from the inter-chip link interface logic 503a of the first chip 203a (e.g. master memory controller), and extracts the target chip ID and target local address, and supplies the target chip ID to the chip ID test function 618. The chip ID test function 618 checks whether the target ID matches the local chip ID, and if so sends an indication 664 to the address decoder 620 to cause it to decode the local address. This in turn causes the Cbus initiator 626 to route the configuration setting from the tunnelled Cbus request to the corresponding local Cbus target 628 (one of the local chip-configuration registers 105) via the Cbus 106.

If on the other hand the target chip ID does not match the local chip ID of the second chip 202, then the ID test function 618 issues an indication 666 to the chip-to-target look-up function 622, causing the look-up function 622 to determine which further chip the Cbus request is destined for. The target test function 624 may determine whether a chip with the target ID exists in the network, and if not issue an error signal 625. Otherwise if the target chip does exist, the Cbus initiator 626 issues a corresponding Cbus tunnelling request to a local downstream-facing tunnelling proxy 630 in the down-link facing inter-chip link interface logic 303b of the second chip 202. The downstream-facing tunnelling proxy 630 forms the Cbus request to be forwarded into a tunnelled Cbus request 668, and forwards to the inter-chip link interface logic 503b of a third chip (e.g. slave memory controller) 203b, via at least one link 205 of the inter-chip interconnect 207. The third chip 203a is selected as that being the target chip as specified by the target ID.

The inter-chip link interface logic 503b of the third chip 203b (e.g. slave memory controller) comprises a local upstream-facing tunnelling proxy 632, a chip ID test function 634, an address decoder 636, a chip-to-target look-up function 638, a Cbus target test function 640, and a Cbus initiator function 642. The local upstream-facing tunnelling proxy 632 receives the tunnelled Cbus request forwarded from the inter-chip link interface logic 303 of the second chip 202 (e.g. accelerator processor), and extracts the target ID and local address. The chip ID test function 634 determines whether the target chip ID matches the local chip ID. If so, the ID test function 634 issues an indication 670 to the address decoder to cause it to decode the local address, and in turn the address decoder causes the Cbus initiator 642 to issue a local Cbus request to the corresponding local Cbus target (one of the local chip-configuration registers 105) via the Cbus 106. If on the other hand the target chip ID does not match the local chip ID, then the chip ID test function 634 may issue an indication 672 to the chip-to-target look-up function 638 and Cbus target test function 638 which check whether the target chip ID exists according to the third chip's own look-up table, and if not raise an error signal 641. This could happen is if there is a mis-configuration in one of the look-up tables. If the look-up tables are consistent, then such an error should in principle not be possible.

In embodiments the tunnelling proxies 614, 630 which pack CBus packets into Ethernet Frames and passes them to an Ethernet controller (not shown) to back packaged into the tunnelled requests 662, 668 (respectively) in the form of Ethernet frames. At the other end of the link the UF logic 616, 632 (respectively) unpacks the packet from the received frame and, if destined for the receiving chip, places it onto the local Cbus 105.

In embodiments responses to the Cbus request may be sent back to the host 201. Response packets are handled in a similar way as described herein but in the reverse direction.

It will be appreciated that the above embodiments have been described by way of example only.

More generally, according to one aspect disclosed herein there may be provided a computer system comprising: a plurality of chips, each comprising a respective local chip-configuration control bus arranged to communicate chip configuration settings to chip-configuration registers of the chip and thereby configure the chip, each chip-configuration register having an address within a local chip-configuration register address space of the respective chip; an inter-chip data interconnect arranged to communicate application data content between different ones of the chips; and a host, wherein a first of the plurality of chips is connected to the host via a host interconnect other than the inter-chip data interconnect, but a second of the plurality of chips is not connected to the host other than via the first chip and the inter-chip data interconnect; wherein the first chip is arranged so as: a) based on information from the host received via the host interconnect, to obtain chip-configuration requests each comprising a target chip ID specifying a target chip from among the plurality of chips, a target chip-configuration register address specifying a target chip-configuration register on the target chip, and a target chip-configuration setting; b) when the target chip ID matches a chip ID of the first chip, to supply the target chip-configuration setting via the local chip-configuration control bus of the first chip to the target chip-configuration register address within the local chip-configuration register address space of the first chip; and c) when the target chip ID matches a chip ID of the second chip, to cause the chip-configuration request to be tunnelled over the inter-chip data interconnect to the second chip, where the second chip is configured to supply the tunnelled chip-configuration setting via the respective chip-configuration control bus of the second chip to the target chip-configuration register address within the chip-configuration register address space of the second chip.

In embodiments, the host interconnect may be a PCI bus.

In embodiment, the inter-chip data interconnect may be a network of Ethernet links.

In embodiments, the chip ID of each of the first and second chips may be programmed into a respective register on the chip.

In embodiments, the plurality of chips may comprises at least three chips, including one or more third chips. In such embodiments, the first chip may be further configured to: d) when the target chip ID matches a chip ID of a target one of the third chips, to cause the chip-configuration request to be tunnelled over the inter-chip data interconnect to the second chip. The second chip may be configured to: e) when the target chip ID of one of the chip-configuration requests tunnelled to the second chip matches the chip ID of the second chip, to perform the supply of the target chip-configuration setting via the respective local chip-configuration control bus of the second chip to the target chip-configuration register address within the local chip-configuration register address space of the second chip; and f) when the target chip ID of one of the chip-configuration requests tunnelled to the second chip matches a chip ID of the target third chip, to cause the chip-configuration request to be tunnelled over the inter-chip data interconnect to the target third chip, where the target third chip is configured to supply the tunnelled chip-configuration setting via the respective chip-configuration control bus of the target third chip to the target chip-configuration register address within the chip-configuration register address space of the target third chip.

In embodiments the chip-configuration settings may comprise settings which effectuate any one or more of: i) setting whether a pin is input or output pin; ii) driving a value onto a pin or reading whether a pin is high or low; iii) injecting debug state or causing read-out of debug state; iv) programming the chip ID of the respective chip; v) programming a chip ID look-up table used for the tunnelling of chip-configuration requests; vi) configuring a source of global timing information; vii) turning on or off host interface logic onboard the respective chip; viii) configuring error handling or debugging circuitry; or ix) enabling, disabling or otherwise configuring one or more other modules of hardware logic on the chip.

In embodiments, the plurality of chips may comprise an accelerator processor chip and one or more memory controller chips.

In embodiments, the accelerator processor chip may comprise multiple processor tiles on the same chip.

In embodiments, the plurality of chips may comprise multiple memory controller chips per accelerator processor chip.

In embodiments, the first chip may be one of the memory controller chips and the second chip may be the accelerator processor chip.

In embodiments, the one or more third chips may each be one of the memory controller chips.

In embodiments, the one or more third chips may each be one of the memory controller chips.

In embodiments, the system may further comprise at least one microcontroller, each microcontroller being arranged to issue chip-configuration settings to the chip-configuration registers of a respective one or more of the chips via the respective chip-configuration control bus of the respective chip.

In embodiments, the at least one microcontroller may be arranged to configure the plurality of chips on boot of the computer system and the host may be arranged to make changes to the configuration after boot.

In embodiments, the at least one microcontroller may comprise one microcontroller per multiple chips, with one or more chip-select pins to select between the multiple chips as a target of the configuration by said one of the microcontrollers.

In embodiments, said one of the microcontrollers may be one microcontroller per multiple of the memory controller chips.

In embodiments, the system may comprise at least two microcontrollers, including at least said one microcontroller per multiple memory controllers, and at least one further microcontroller arranged to configure the accelerator processor chip.

In embodiments, each microcontroller may be arranged to issue its configuration settings to its respective one or more chips via JTAG or SPI interface.

In embodiments, the accelerator processor chip may further comprise a CPU which can also issue further chip-configuration settings to the chip-configuration registers of the accelerator processor chip via the respective chip-configuration control bus of the accelerator processor.

In embodiments, the first chip may be configured to obtain chip-configuration requests by decoding the information from the host.

According to further aspects disclosed herein there may be provided a corresponding method of operating the system of any embodiment disclosed herein.

Other variants or use cases of the disclosed techniques may become apparent to the person skilled in the art once given the disclosure herein. The scope of the disclosure is not limited by the described embodiments but only by the accompanying claims.

1. A computer system comprising:
a plurality of chips, each comprising a respective local chip-configuration control bus arranged to communicate chip configuration settings to chip-configuration registers of the chip and thereby configure the chip, each chip-configuration register having an address within a local chip-configuration register address space of the respective chip;
an inter-chip data interconnect arranged to communicate application data content between different ones of the chips; and
a host, wherein a first of the plurality of chips is connected to the host via a host interconnect other than the inter-chip data interconnect, but a second of the plurality of chips is not connected to the host other than via the first chip and the inter-chip data interconnect;
wherein the first chip is arranged to: a) based on information from the host received via the host interconnect, obtain chip-configuration requests each comprising a target chip ID specifying a target chip from among the plurality of chips, a target chip-configuration register address specifying a target chip-configuration register on the target chip, and a target chip-configuration setting; b) when the target chip ID matches a chip ID of the first chip, supply the target chip-configuration setting via the local chip-configuration control bus of the first chip to the target chip-configuration register address within the local chip-configuration register address space of the first chip; and c) when the target chip ID matches a chip ID of the second chip, cause the chip-configuration request to be tunnelled over the inter-chip data interconnect to the second chip, where the second chip is configured to supply the tunnelled chip-configuration setting via the respective chip-configuration control bus of the second chip to the target chip-configuration register address within the chip-configuration register address space of the second chip.

2. The computer system of claim 1, wherein the host interconnect is a PCI bus.

3. The computer system of claim 1, wherein the inter-chip data interconnect is a network of Ethernet links.

4. The computer system of claim 1, wherein the chip ID of each of the first and second chips is programmed into a respective register on the chip.

5. The computer system of claim 1, wherein the plurality of chips comprises at least three chips, including one or more third chips;
wherein the first chip is further configured to: d) when the target chip ID matches a chip ID of a target one of the third chips, to cause the chip-configuration request to be tunnelled over the inter-chip data interconnect to the second chip; and
the second chip is configured to: e) when the target chip ID of one of the chip-configuration requests tunnelled to the second chip matches the chip ID of the second chip, to perform the supply of the target chip-configuration setting via the respective local chip-configuration control bus of the second chip to the target chip-configuration register address within the local chip-configuration register address space of the second chip, and f) when the target chip ID of one of the chip-configuration requests tunnelled to the second chip matches a chip ID of the target third chip, to cause the chip-configuration request to be tunnelled over the inter-chip data interconnect to the target third chip, where the target third chip is configured to supply the tunnelled chip-configuration setting via the respective chip-configuration control bus of the target third chip to the target chip-configuration register address within the chip-configuration register address space of the target third chip.

6. The computer system of claim 1, wherein the chip-configuration settings comprise settings which effectuate any one or more of:
setting whether a pin is input or output pin,
driving a value onto a pin or reading whether a pin is high or low,
injecting debug state or causing read-out of debug state,
programming the chip ID of the respective chip,
programming a chip ID look-up table used for the tunnelling of chip-configuration requests,
configuring a source of global timing information,
turning on or off host interface logic onboard the respective chip,
configuring error handling or debugging circuitry, or
enabling, disabling or otherwise configuring one or more other modules of hardware logic on the chip.

7. The computer system of claim 1, wherein the plurality of chips comprises an accelerator processor chip and one or more memory controller chips.

8. The computer system of claim 7, wherein the accelerator processor chip comprises multiple processor tiles on the same chip.

9. The computer system of claim 7, wherein the plurality of chips comprises multiple memory controller chips per accelerator processor chip.

10. The computer system of claim 7, wherein the first chip is one of the memory controller chips and the second chip is the accelerator processor chip.

11. The computer system of any of claim 5, wherein the plurality of chips comprises an accelerator processor chip and one or more memory controller chips, and the one or more third chips are each one of the memory controller chips.

12. The computer system of claim 5, wherein the plurality of chips comprises an accelerator processor chip and one or more memory controller chips, the first chip is one of the memory controller chips and the second chip is the accelerator processor chip, and the one or more third chips are each one of the memory controller chips.

13. The computer system of claim 1, further comprising at least one microcontroller, each microcontroller being arranged to issue chip-configuration settings to the chip-configuration registers of a respective one or more of the chips via the respective chip-configuration control bus of the respective chip.

14. The computer system of claim 13, wherein the at least one microcontroller is arranged to configure the plurality of chips on boot of the computer system and the host is arranged to make changes to the configuration after boot.

15. The computer system of claim 13, wherein the at least one microcontroller comprises one microcontroller per multiple chips, with one or more chip-select pins to select between the multiple chips as a target of the configuration by said one of the microcontrollers.

16. The computer system of claim 15, wherein the plurality of chips comprises one or more accelerator processor chips and multiple memory controller chips per accelerator processor chip, and said one of the microcontrollers is one microcontroller per multiple of the memory controller chips.

17. The computer system of claim 16, comprising at least two microcontrollers, including at least said one microcontroller per multiple memory controllers, and at least one further microcontroller arranged to configure the accelerator processor chip.

18. The computer system of claim 13, wherein each microcontroller is arranged to issue its configuration settings to its respective one or more chips via JTAG or SPI interface.

19. The computer system of claim 8, wherein the accelerator processor chip further comprises a CPU which can also issue further chip-configuration settings to the chip-configuration registers of the accelerator processor chip via the respective chip-configuration control bus of the accelerator processor.

20. A method of configuring a plurality of chips, each comprising a respective local chip-configuration control bus arranged to communicate chip configuration settings to chip-configuration registers of the chip and thereby configure the chip, each chip-configuration register having an address within a local chip-configuration register address space of the respective chip; wherein an inter-chip data interconnect is arranged to communicate application data content between different ones of the chips;
the method comprising, by a first of the plurality of chips connected to a host via a host interconnect other than the inter-chip data interconnect, wherein a second of the plurality of chips is not connected to the host other than via the first chip and the inter-chip data interconnect:
a) based on information from the host received via the host interconnect, obtaining chip-configuration requests each comprising a target chip ID specifying a target chip from among the plurality of chips, a target chip-configuration register address specifying a target chip-configuration register on the target chip, and a target chip-configuration setting;
b) when the target chip ID matches a chip ID of the first chip, supplying the target chip-configuration setting via the local chip-configuration control bus of the first chip to the target chip-configuration register address within the local chip-configuration register address space of the first chip; and
c) when the target chip ID matches a chip ID of the second chip, causing the chip-configuration request to be tunnelled over the inter-chip data interconnect to the second chip, where the second chip is configured to supply the tunnelled chip-configuration setting via the respective chip-configuration control bus of the second chip to the target chip-configuration register address within the chip-configuration register address space of the second chip.
